(19) United States
(12) Patent Application Publication
(10) Pub. No.: US 2016/0275169 A1
(43) Pub. Date: Sep. 22, 2016

(54) SYSTEM AND METHOD OF GENERATING INITIAL CLUSTER CENTROIDS

(71) Applicant: Infoutopia Co., Ltd., Taipei City (TW)

(72) Inventors: Tsung-Hsiung LEE, Taipei City (TW); I-Hsun CHIU, Taipei City (TW)

(21) Appl. No.: 14/660,127

(22) Filed: Mar. 17, 2015

(51) Int. Cl. G06F 17/30; G06K 9/62

(52) U.S. Cl. CPC G06F 17/30598; G06K 9/6223; G06K 9/6247; G06F 17/30539

(57) ABSTRACT

A computer system includes a processor and a computer-readable storage medium. The computer-readable storage medium has stored therein instructions that when executed by the processor perform a method for generating initial cluster centroids. The method includes generating (Key1, Value1) pairs of input datasets. The method also includes calculating global designated values, among the generated (Key1, Value1) pairs, to be reference values. The method also includes calculating similarity values of the input datasets based on the reference values. The method further includes generating (Key2, Value2) pairs of input datasets. The method further includes generating median similarity value, among the generated (Key2, Value2) pairs, to generate corresponding initial cluster centroids. The Key1 and the Value1 are a feature variable and a feature value, respectively, of corresponding input dataset. The Key2 and the Value2 are the similarity value and the feature value, respectively, of corresponding input dataset.

### BACKGROUND OF THE INVENTION

1. Field of the Invention

The present invention relates generally to data mining and more particularly to a system to generate initial cluster centroids.

2. Description of the Related Art

Clustering is an important area of application for a wide range of fields such as data mining, statistical data analysis, compression, and vector quantization. A k-means clustering algorithm is the most popular partition based, iterative algorithm for clustering analysis. These iterative techniques are especially sensitive to initial starting conditions. Therefore, the result of running the k-means clustering algorithm on the same workload varies depending on the chosen initial starting points.

### BRIEF SUMMARY OF THE INVENTION

According to one aspect of the disclosure, a method of generating initial cluster centroids using a processor, comprises the steps of: using the processor, generating (Key1, Value1) pairs of input datasets; using the processor, calculating global designated values, among the generated (Key1, Value1) pairs, to be reference values; using the processor, calculating similarity values of the input datasets based on the reference values; and using the processor, generating median similarity values based on the similarity values of the input datasets to generate corresponding initial cluster centroids; wherein the Key1 and the Value1 are a feature variable and a feature value, respectively, of corresponding input dataset; the processor runs the steps of generating (Key1, Value1) pairs, the steps of calculating global designated values, the steps of calculating similarity values and the steps of generating median similarity values by executing a set of instructions storing in a machine readable storage medium.

According to another aspect of the disclosure, a computer program product tangibly is embodied in a machine readable storage medium comprising instructions that when executed by a processor perform a method for generating initial cluster centroids. The method comprises the steps of: calculating global designated values, among a plurality of input datasets, to be reference values; calculating similarity values of the plurality of input datasets based on the reference values; and generating median similarity values based on the similarity values of the plurality of input datasets to generate corresponding initial cluster centroids.

According to another aspect of the disclosure, a computer system comprises: a processor; and a computer-readable storage medium having stored therein instructions that when executed by the processor perform a method for generating initial cluster centroids. The method performed by the processor comprises: generating (Key1, Value1) pairs of input datasets; calculating global designated values, among the generated (Key1, Value1) pairs, to be reference values; calculating similarity values of the input datasets based on the reference values; generating (Key2, Value2) pairs of input datasets; and generating median similarity value, among the generated (Key2, Value2) pairs, to generate corresponding initial cluster centroids, wherein the Key1 and the Value1 are a feature variable and a feature value, respectively, of corresponding input dataset; the Key2 and the Value2 are the similarity value and the feature value, respectively, of corresponding input dataset.

### BRIEF DESCRIPTION OF THE DRAWINGS

One or more embodiments are illustrated by way of example, and not by limitation, in the figures of the accompanying drawing, wherein elements having the same reference numeral designations represent like elements throughout. It is emphasized that, in accordance with standard practice in the industry various features may not be drawn to scale and are used for illustration purposes only. For a more complete understanding of the present invention, and the advantages thereof, reference is now made to the following descriptions taken in conjunction with the accompanying drawing, in which:

FIG. 1 is a plurality of input datasets 100 according to some embodiments.

FIG. 2 is a flowchart 200 for selection of initial cluster centroids according to some embodiments.

FIG. 3 is a flowchart 300 for generating reference values of input datasets according to some embodiments.

FIG. 4 is a flowchart 400 for calculating similarities of input datasets according to some embodiments.

FIG. 5 is a flowchart 500 for generating initial cluster centroids of input datasets according to some embodiments.

FIG. 6 is a processing system 600 according to some embodiments.

### DETAILED DESCRIPTION OF THE INVENTION

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

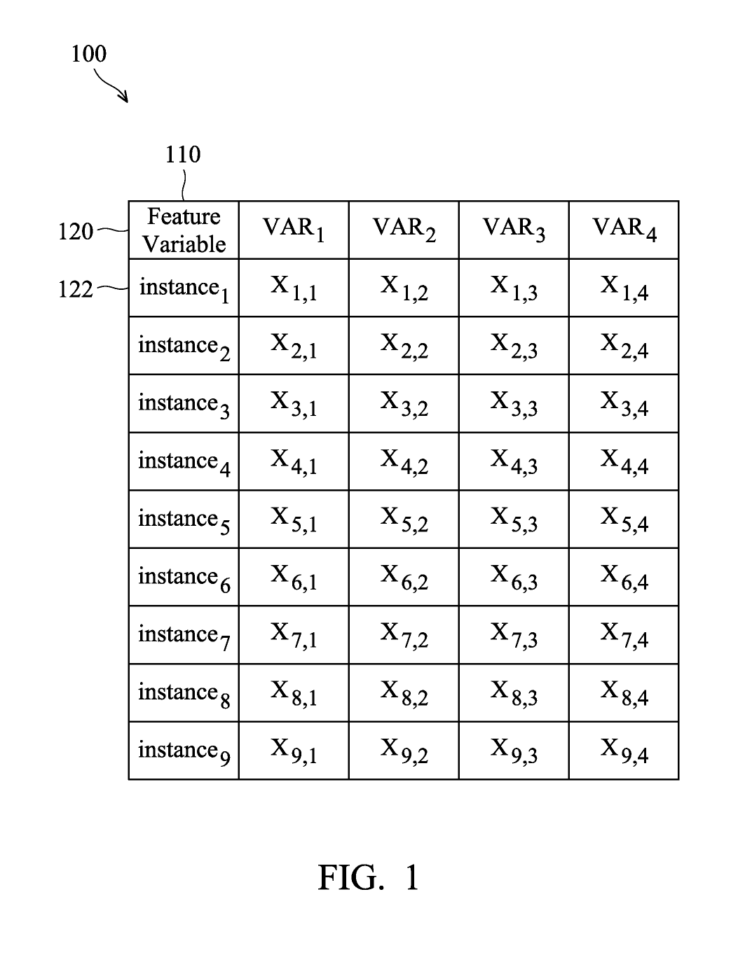

FIG. 1 is a plurality of input datasets 100 according to some embodiments. The plurality of input datasets includes nine instances, instance₁-instance₉, as shown in column 110. Each of the nine instances includes four feature variables, VAR₁-VAR₄, as shown in row 120. For simplicity, only nine instances and four feature variables are shown in FIG. 1, any number of instances and feature variables are within the scope of various embodiments. The notation X_{i,j} represents a feature value of i^{th} instance, instanceᵢ, and j^{th} feature variable, VARⱼ. For example, X_{1,2} in row 122 represents a feature value of 1^{st} instance, instance₁, and 2^{nd} feature variable, VAR₂.

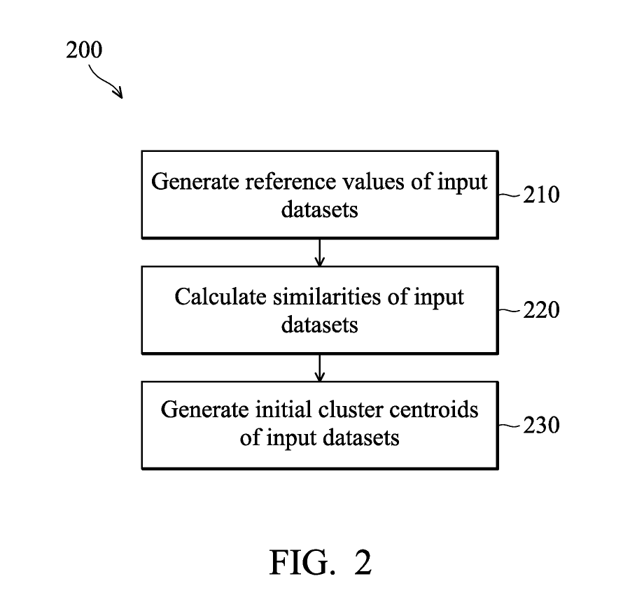

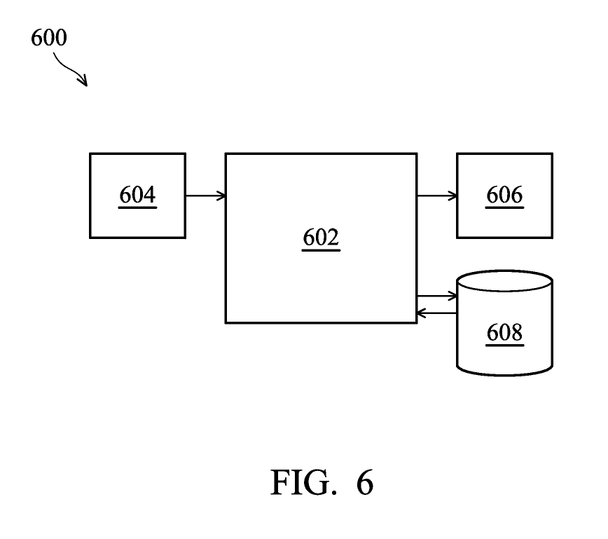

FIG. 2 is a flowchart 200 for selection of initial cluster centroids according to some embodiments. In some embodiments, operations 210-230 in FIG. 2 can be implemented as computer-readable code stored on a tangible computer-readable medium, for execution by one or more processors, for example embodiments in FIG. 6. In some embodiments, implementations of each of steps 210-230 are done according to MapReduce models and processes developed by Google Inc. The MapReduce processes include map, combine, shuffle/sort and reduce.

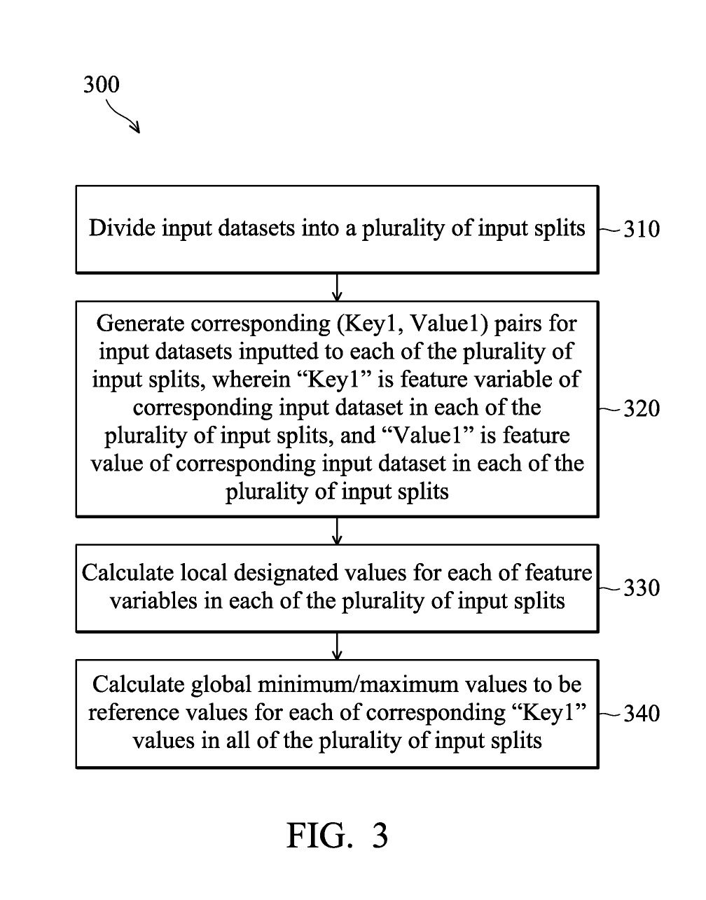

In operation 210, reference values of input datasets are generated. In some embodiments, global minimum values of the plurality of input datasets are generated to be reference values. In some embodiments, global maximum values of the plurality of input datasets are generated to be reference values. A flowchart 300 in FIG. 3 is an example to implement the operation 210.

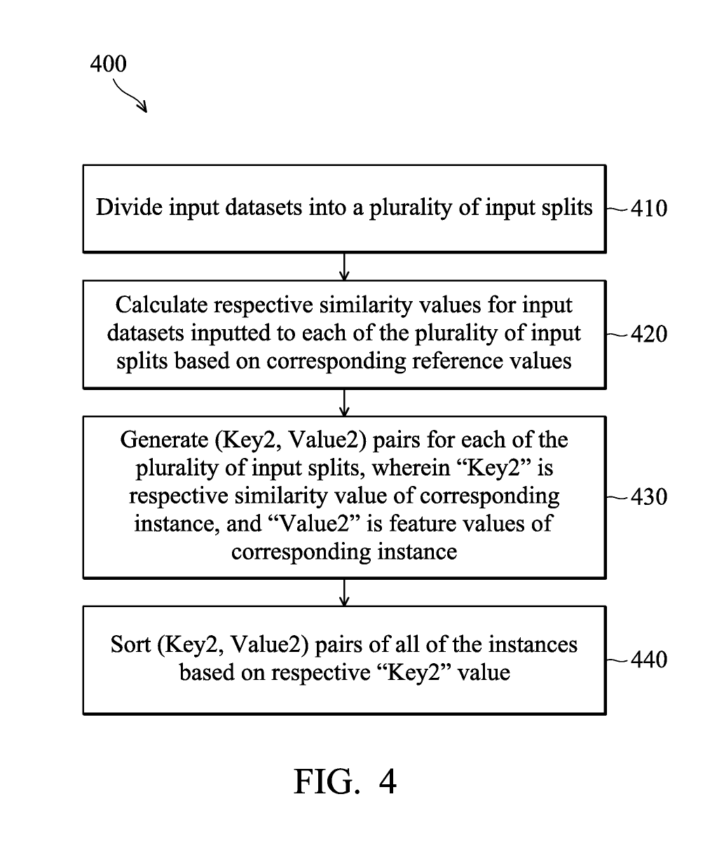

In operation 220, similarity values of input datasets are calculated. To calculate the similarity values of input datasets, any logical and/or arithmetic operations, or any algorithms, or any distance formulas are within the scope of various embodiments. A flowchart 400 in FIG. 4 is an example to implement the operation 220.

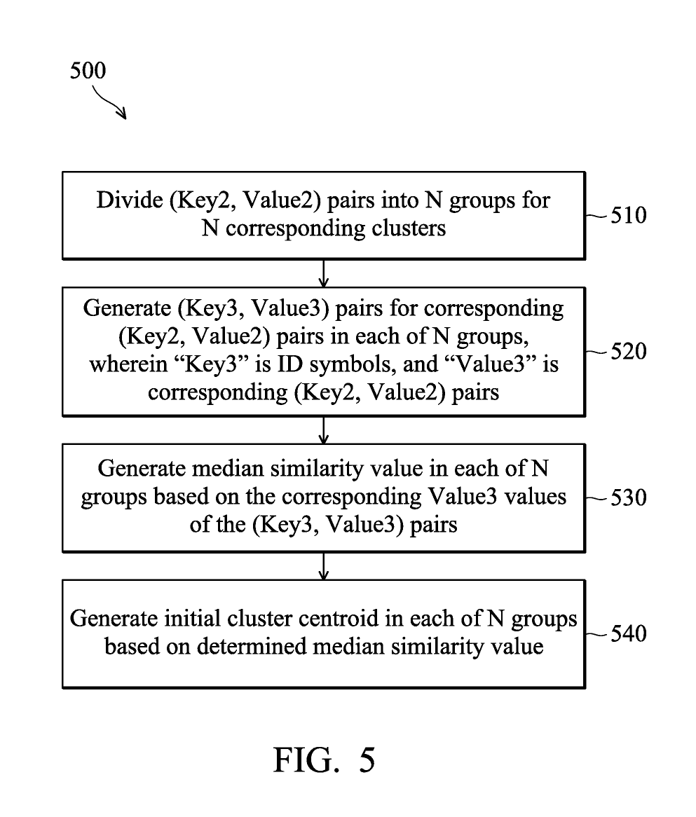

In operation 230, initial cluster centroids of input datasets are generated based on the calculated similarity values for each of clusters. A flowchart 500 in FIG. 5 is an example to implement the operation 230.

FIG. 3 is a flowchart 300 for generating reference values of input datasets according to some embodiments. In some embodiments, the flowchart 300 in FIG. 3 implements the operation 210 of the flowchart 200 in FIG. 2. In some embodiments, operations 310-340 in FIG. 3 are implemented as computer-readable code stored on a tangible computer-readable medium, for execution by one or more processors, for example embodiments in FIG. 6. In some embodiments, implementations of each of steps 310-340 are done according to MapReduce models and processes.

In operation 310, input datasets are divided into a plurality of input splits. The number of input splits is chosen based on cost and performance consideration. For simplicity, three input splits are selected for illustration purpose in FIG. 3-5, but it is understood that any number of input splits are within the scope of various embodiments. In some embodiments, the instance₁-instance₃ are inputted to input split₁, the instance₄-instance₆ are inputted to input split₂, the instance₇-instance₉ are inputted to input split₃.

In operation 320, the corresponding (Key1, Value1) pairs are generated for input datasets inputted to each of the plurality of input splits. In some embodiments, (Key1, Value1) pairs are generated for each of the instances of corresponding input split. The “Key1” of the (Key1, Value1) pair is a feature variable of corresponding input dataset. The “Value1” of the (Key1, Value1) pair is a feature value of corresponding input dataset. In some embodiments, (Key1, Value1) pairs are generated in map stage of the MapReduce processes.

For example, the generated (Key1, Value1) pairs in the input split₁ regarding the input datasets 100 in FIG. 1 are (VAR₁, X_{1,1}), (VAR₂, X_{1,2}), (VAR₃, X_{1,3}), (VAR₄, X_{1,4}), (VAR₁, X_{2,1}), (VAR₂, X_{2,2}), (VAR₃, X_{2,3}), (VAR₄, X_{2,4}), (VAR₁, X_{3,1}), (VAR₂, X_{3,2}), (VAR₃, X_{3,3}), (VAR₄, X_{3,4}).

The generated (Key1, Value1) pairs in the input split₂ regarding the input datasets 100 in FIG. 1 are (VAR₁, X_{4,1}), (VAR₂, X_{4,2}), (VAR₃, X_{4,3}), (VAR₄, X_{4,4}), (VAR₁, X_{5,1}), (VAR₂, X_{5,2}), (VAR₃, X_{5,3}), (VAR₄, X_{5,4}), (VAR₁, X_{6,1}), (VAR₂, X_{6,2}), (VAR₃, X_{6,3}), (VAR₄, X_{6,4}).

The generated (Key1, Value1) pairs in the input split₃ regarding the input datasets 100 in FIG. 1 are (VAR₁, X_{7,1}), (VAR₂, X_{7,2}), (VAR₃, X_{7,3}), (VAR₄, X_{7,4}), (VAR₁, X_{8,1}), (VAR₂, X_{8,2}), (VAR₃, X_{8,3}), (VAR₄, X_{8,4}), (VAR₁, X_{9,1}), (VAR₂, X_{9,2}), (VAR₃, X_{9,3}), (VAR₄, X_{9,4}).

In operation 330, local designated values for each of feature variables in each of the plurality of input splits are calculated. In some embodiments, the local designated values are minimum values of feature values of corresponding feature variables in each of the plurality of input splits. In some embodiments, the local designated values are maximum values of feature values of corresponding feature variables in each of the plurality of input splits. In some embodiments, the local designated value is a result of logical and/or arithmetic operations that takes feature values of corresponding feature variables into consideration. The logical operations include AND, NAND, OR, NOR, NOT, SHIFT, exclusive OR, exclusive NOR, etc. The arithmetic operations include addition, subtraction, multiplication, division, remainder, etc. In some embodiments, the local designated values are calculated in combine stage of the MapReduce processes.

For simplicity, minimum values of feature values of corresponding feature variables are selected to be the local designated values in FIG. 3. As a result, the local designated values of the input split₁ for each of feature variables are (VAR₁, XIS₁min₁), (VAR₂, XIS₁min₂), (VAR₃, XIS₁min₃) and (VAR₄, XIS₁min₄). The XIS₁min₁ is a minimum value among feature values X_{1,1}, X_{2,1}, and X_{3,1} in the input split₁. The XIS₁min₂ is a minimum value among feature values X_{1,2}, X_{2,2}, and X_{3,2} in the input split₁. The XIS₁min₃ is a minimum value among feature values X_{1,3}, X_{2,3}, and X_{3,3} in the input split₁. The XIS₁min₄ is a minimum value among feature values X_{1,4}, X_{2,4}, and X_{3,4} in the input split₁.

The local designated values of the input split₂ for each of feature variables are (VAR₁, XIS₂min₁), (VAR₂, XIS₂min₂), (VAR₃, XIS₂min₃) and (VAR₄, XIS₂min₄). The XIS₂min₁ is a minimum value among feature values X_{4,1}, X_{5,1}, and X_{6,1} in the input split₂. The XIS₂min₂ is a minimum value among feature values X_{4,2}, X_{5,2}, and X_{6,2} in the input split₂. The XIS₂min₃ is a minimum value among feature values X_{4,3}, X_{5,3}, and X_{6,3} in the input split₂. The XIS₂min₄ is a minimum value among feature values X_{4,4}, X_{5,4}, and X_{6,4} in the input split₂.

The local designated values of the input split₃ for each of feature variables are (VAR₁, XIS₃min₁), (VAR₂, XIS₃min₂), (VAR₃, XIS₃min₃) and (VAR₄, XIS₃min₄). The XIS₃min₁ is a minimum value among feature values X_{7,1}, X_{8,1}, and X_{9,1} in the input split₃. The XIS₃min₂ is a minimum value among feature values X_{7,2}, X_{8,2}, and X_{9,2} in the input split₃. The XIS₃min₃ is a minimum value among feature values X_{7,3}, X_{8,3}, and X_{9,3} in the input split₃. The XIS₃min₄ is a minimum value among feature values X_{7,4}, X_{8,4}, and X_{9,4} in the input split₃.

In operation 340, global designated values are calculated to be reference values in all of the plurality of input splits. In some embodiments, the global designated values are minimum values of feature values of corresponding feature variables in all of the plurality of input splits. In some embodiments, the global designated values are maximum values of feature values of corresponding feature variables in all of the plurality of input splits. In some embodiments, the global designated value is a result of logical and/or arithmetic operations that takes feature values of corresponding feature variables into consideration. The logical operations include AND, NAND, OR, NOR, NOT, SHIFT, exclusive OR, exclusive NOR, etc. The arithmetic operations include addition, subtraction, multiplication, division, remainder, etc. In some embodiments, the global designated values are calculated in reduce stage of the MapReduce processes.

For example, the global designated values of all of the plurality of input splits are (VAR₁, Xmin₁), (VAR₂, Xmin₂), (VAR₃, Xmin₃) and (VAR₄, Xmin₄). The Xmin₁ is a minimum value among the local designated values XIS₁min₁, XIS₂min₁, and XIS₃min₁. The Xmin₂ is a minimum value among the local designated values XIS₁min₂, XIS₂min₂ and XIS₃min₂ The Xmin₃ is a minimum value among the local designated values XIS₁min₃, XIS₂min₃ and XIS₃min₃. The Xmin₄ is a minimum value among the local designated values XIS₁min₄, XIS₂min₄ and XIS₃min₄.

FIG. 4 is a flowchart 400 for calculating similarities of input datasets according to some embodiments. In some embodiments, the flowchart 400 in FIG. 4 implements the operation 220 of the flowchart 200 in FIG. 2. In some embodiments, operations 410-440 in FIG. 4 are implemented as computer-readable code stored on a tangible computer-readable medium, for execution by one or more processors, for example embodiments in FIG. 6.

In operation 410, input datasets are divided into a plurality of input splits. For simplicity, three input splits are selected for illustration purpose in FIG. 4.

In operation 420, similarity values for input datasets inputted to each of the plurality of input splits are calculated based on corresponding reference values calculated in the flowchart 300 in FIG. 3. To calculate the similarity values of input datasets, any logical and/or arithmetic operations, or any algorithms, or any distance formulas are within the scope of various embodiments. For example, a formula of squared Euclidean distance is used as an example in FIG. 4 to calculate the similarity values. In some embodiments, the similarity values are calculated in map stage of the MapReduce processes.

For example, the similarity value IS₁S₁ for instance₁ in input split₁ is calculated based on an equation (1).

IS₁S₁=(X_{1,1}−Xmin₁)²+(X_{1,2}−Xmin₂)²+(X_{1,3}−Xmin₃)²+(X_{1,4}−Xmin₄)² (1)

The similarity value IS₁S₂ for instance₂ in input split₁ is calculated based on an equation (2).

IS₁S₂=(X_{2,1}−Xmin₁)²+(X_{2,2}−Xmin₂)²+(X_{2,3}−Xmin₃)²+(X_{2,4}−Xmin₄)² (2)

The similarity value IS₁S₃ for instance₃ in input split₁ is calculated based on an equation (3).

IS₁S₃=(X_{3,1}−Xmin₁)²+(X_{3,2}−Xmin₂)²+(X_{3,3}−Xmin₃)²+(X_{3,4}−Xmin₄)² (3)

The similarity value IS₂S₄ for instance₄ in input split₂ is calculated based on an equation (4).

IS₂S₄=(X_{4,1}−Xmin₁)²+(X_{4,2}−Xmin₂)²+(X_{4,3}−Xmin₃)²+(X_{4,4}−Xmin₄)² (4)

The similarity value IS₂S₅ for instance₅ in input split₂ is calculated based on an equation (5).

IS₂S₅=(X_{5,1}−Xmin₁)²+(X_{5,2}−Xmin₂)²+(X_{5,3}−Xmin₃)²+(X_{5,4}−Xmin₄)² (5)

The similarity value IS₂S₆ for instance₆ in input split₂ is calculated based on an equation (6).

IS₂S₆=(X_{6,1}−Xmin₁)²+(X_{6,2}−Xmin₂)²+(X_{6,3}−Xmin₃)²+(X_{6,4}−Xmin₄)² (6)

The similarity value IS₃S₇ for instance₇ in input split₃ is calculated based on an equation (7).

IS₃S₇=(X_{7,1}−Xmin₁)²+(X_{7,2}−Xmin₂)²+(X_{7,3}−Xmin₃)²+(X_{7,4}−Xmin₄)² (7)

The similarity value IS₃S₈ for instance₅ in input split₃ is calculated based on an equation (8).

IS₃S₈=(X_{8,1}−Xmin₁)²+(X_{8,2}−Xmin₂)²+(X_{8,3}−Xmin₃)²+(X_{8,4}−Xmin₄)² (8)

The similarity value IS₃S₉ for instance₉ in input split₃ is calculated based on an equation (9).

IS₃S₉=(X_{9,1}−Xmin₁)²+(X_{9,2}−Xmin₂)²+(X_{9,3}−Xmin₃)²+(X_{9,4}−Xmin₄)² (9)

In operation 430, (Key2, Value2) pairs for each of the instances of the plurality of input splits are generated. The Key2 values are respective similarity value of corresponding instance calculated by the equations (1)-(9). The Value2 values are feature values of corresponding instance in FIG. 1. In some embodiments, the (Key2, Value2) pairs are generated in map stage of the MapReduce processes.

For example, the (Key2, Value2) pairs for instance₁ is (IS₁S₁, {X_{1,1}, X_{1,2}, X_{1,3}, X_{1,4}}). The (Key2, Value2) pairs for instance₂ is (IS₁S₂, {X_{2,1}, X_{2,2}, X_{2,3}, X_{2,4}}). The (Key2, Value2) pairs for instance₃ is (IS₁S₃, {X_{3,1}, X_{3,2}, X_{3,3}, X_{3,4}}). The (Key2, Value2) pairs for instance₄ is (IS₂S₄, {X_{4,1}, X_{4,2}, X_{4,3}, X_{4,4}}). The (Key2, Value2) pairs for instance₅ is (IS₂S₅, {X_{5,1}, X_{5,2}, X_{5,3}, X_{5,4}}). The (Key2, Value2) pairs for instance₆ is (IS₂S₆, {X_{6,1}, X_{6,2}, X_{6,3}, X_{6,4}}). The (Key2, Value2) pairs for instance₇ is (IS₃S₇, {X_{7,1}, X_{7,2}, X_{7,3}, X_{7,4}}). The (Key2, Value2) pairs for instance₈ is (IS₃S₈, {X_{8,1}, X_{8,2}, X_{8,3}, X_{8,4}}). The (Key2, Value2) pairs for instance₉ is (IS₃S₉, {X_{9,1}, X_{9,2}, X_{9,3}, X_{9,4}}).

In operation 440, (Key2, Value2) pairs of all of the instances are sorted based on respective “Key2” value. In some embodiments, the (Key2, Value2) pairs are sorted in shuffle/sort stage of the MapReduce processes.

In some embodiments, the similarity values IS₁S₁-IS₃S₉ are sorted in increasing order. In some embodiments, the similarity values IS₁S₁-IS₃S₉ are sorted in decreasing order. In some embodiments, the similarity values IS₁S₁-IS₃S₉ are sorted in a specific order based on results of arithmetic/logical operations. In FIG. 4, the similarity values IS₁S₁-IS₃S₉ are used as an example to represent sorted result in increasing order.

FIG. 5 is a flowchart 500 for generating initial cluster centroids of input datasets according to some embodiments. In some embodiments, the flowchart 500 in FIG. 5 implements the operation 230 of the flowchart 200 in FIG. 2. In some embodiments, operations 510-540 in FIG. 5 are implemented as computer-readable code stored on a tangible computer-readable medium, for execution by one or more processors, for example embodiments in FIG. 6.

In operation 510, (Key2, Value2) pairs are further divided into N groups for N corresponding clusters. In k-means clustering algorithm, the input datasets are used to divide into N clusters. As a result, there are N initial cluster centroids that are generated for the corresponding N clusters. In such a situation, (Key2, Value2) pairs of all of the instances are arranged to divide into N groups for the corresponding N clusters. It is understood that any operations, such as arithmetic and/or logical operations, may be used to divide the (Key2, Value2) pairs into N groups, and are within the scope of various embodiments. In some embodiments, the (Key2, Value2) pairs are arranged to divide into N groups in map stage of the MapReduce processes.

For example, the (Key2, Value2) pairs of the instances in FIG. 1 are divided into two groups, first and second groups, for two corresponding clusters. In some embodiments, the (Key2, Value2) pairs in the first group are (IS₁S₁, {X_{1,1}, X_{1,2}, X_{1,3}, X_{1,4}}), (IS₁S₂, {X_{2,1}, X_{2,2}, X_{2,3}, X_{2,4}}), (IS₁S₃, {X_{3,1}, X_{3,2}, X_{3,3}, X_{3,4}}), (IS₂S₄, {X_{4,1}, X_{4,2}, X_{4,3}, X_{4,4}}) and (IS₂S₅, {X_{5,1}, X_{5,2}, X_{5,3}, X_{5,4}}). The (Key2, Value2) pairs in the second group are (IS₂S₆, {X_{6,1}, X_{6,2}, X_{6,3}, X_{6,4}}), (IS₃S₇, {X_{7,1}, X_{7,2}, X_{7,3}, X_{7,4}}), (IS₃S₈, {X_{8,1}, X_{8,2}, X_{8,3}, X_{8,4}}) and (IS₃S₉, {X_{9,1}, X_{9,2}, X_{9,3}, X_{9,4}}).

In operation 520, (Key3, Value3) pairs for corresponding (Key2, Value2) pairs in each of N groups are generated. The Key3 values are ID symbols to specify characteristics of corresponding (Key2, Value2) pairs. In some embodiments, the ID symbols represent specific operations in future processes. In some embodiments, the ID symbols is arranged to specify specific reducers in map stage of the MapReduce process for the corresponding (Key2, Value2) pairs in each of N groups.

For example, an identical ID symbol “1” is specified for all of corresponding (Key2, Value2) pairs such that the (Key3, Value3) pairs for corresponding (Key2, Value2) pairs in the first group are (1, (IS₁S₁, {X_{1,1}, X_{1,2}, X_{1,3}, X_{1,4}})), (1, (IS₁S₂, {X_{2,1}, X_{2,2}, X_{2,3}, X_{2,4}})), (1, (IS₁S₃, {X_{3,1}, X_{3,2}, X_{3,3}, X_{3,4}})), (1, (IS₂S₄, {X_{4,1}, X_{4,2}, X_{4,3}, X_{4,4}})) and (1, (IS₂S₅, {X_{5,1}, X_{5,2}, X_{5,3}, X_{5,4}})). The (Key3, Value3) pairs for corresponding (Key2, Value2) pairs in the second group are (1, (IS₂S₆, {X_{6,1}, X_{6,2}, X_{6,3}, X_{6,4}})), (1, (IS₃S₇, {X_{7,1}, X_{7,2}, X_{7,3}, X_{7,4}})), (1, (IS₃S₈, {X_{8,1}, X_{8,2}, X_{8,3}, X_{8,4}})) and (1, (IS₃S₉, {X_{9,1}, X_{9,2}, X_{9,3}, X_{9,4}})).

In operation 530, median similarity value in each of N groups based on the corresponding similarity values in Value3 values of the (Key3, Value3) pairs are generated. In some embodiments, the median similarity values are determined in reduce stage of the MapReduce processes.

For example, the sequence of similarity values regarding corresponding (Key3, Value3) pairs in the first group is (IS₁S₁, IS₁S₂, IS₁S₃, IS₂S₄, IS₂S₅) such that the median similarity value in the first group is “IS₁S₃” as it is in the middle of the sequence. Furthermore, the sequence of the similarity values regarding corresponding (Key3, Value3) pairs in the second group is (IS₂S₆, IS₃S₇, IS₃S₈, IS₃S₉) such that median similarity value in the second group is calculated based on equation (10).

The median similarity value in the second group=(IS₃S₇+IS₃S₈)/2 (10)

In some embodiments, the median similarity values in the first and/or second groups are determined to be a specific similarity value near the middle of the sequence of similarity values in each of the first and/or second groups. For example, the median similarity values in the first group may be “IS₁S₂”, “IS₁S₃” or “IS₂S₄”. The median similarity values in the second group may be “IS₃S₇” or “IS₃S₈”.

In operation 540, initial cluster centroid in each of N groups are generated based on determined median similarity value. In some embodiments, the median similarity values are determined in reduce stage of the MapReduce processes.

For example, based on the determined median similarity value “IS₁S₃” in the first group, the initial cluster centroid is ({X_{3,1}, X_{3,2}/X_{3,3}, X_{3,4}}). For another example, based on the calculated median similarity value by equation (10) in the second group, the initial cluster centroid is generated based on equation (11).

The initial cluster centroid in the second group=({(X_{7,1}+X_{8,1})/2,(X_{7,2}+X_{8,2})/2,(X_{7,3}+X_{8,3})/2.(X_{7,4}+X_{8,4}/2}) (11)

FIG. 6 is a processing system 600 according to some embodiments. With the processing system 600, the above described methods 200-500 may be implemented in order to generate initial cluster centroids for input datasets. In some embodiments, the processing system 600 may be a digital electronic circuitry or a computer system, including computer hardware, firmware or software, or in combinations of them. In some embodiments, the above described methods are implemented in a computer program product tangibly embodied in an information carrier, e.g., in a machine readable storage device, for execution by a programmable processor; and method steps are performed by a programmable processor executing a program of instructions to perform functions of the described implementations by operating on input data and generating output.

Processing system 600 includes a processor 602, which may include a central processing unit, input/output circuitry, signal processing circuitry, and volatile and/or non-volatile memory. Processor 602 receives input, such as user input, from input device 604. Input device may include one or more of a keyboard, a mouse, a tablet, a contact, sensitive surface, a stylus, a microphone, and the like.

Processor 602 may also receive input, such as models, tables, configurations, program codes, databases, and the like, from machine readable storage medium 608. Machine readable storage medium may be located locally to processor 602, or may be remote from processor 602, in which case communications between processor 602 and machine readable storage medium 608 occur over a network, such as a telephone network, the Internet, a local area network, wide area network, or the like.

Machine readable storage medium 608 may include one or more of a hard disk, magnetic storage, optical storage, non-volatile memory storage, and the like. Included in machine readable storage medium 608 may be database software for organizing data and instructions stored on machine readable storage medium 608. Processing system 600 may include output device 606, such as one or more of a display device, speaker, and the like for outputting information to a user.

In some embodiments, a method of generating initial cluster centroids using a processor includes generating (Key1, Value1) pairs of input datasets using the processor. The method also includes calculating global designated values, among the generated (Key1, Value1) pairs, to be reference values using the processor. The method also includes calculating similarity values of the input datasets based on the reference values using the processor. The method further includes generating median similarity values based on the similarity values of the input datasets to generate corresponding initial cluster centroids using the processor. The Key1 and the Value1 are a feature variable and a feature value, respectively, of corresponding input dataset. The processor runs the steps of generating (Key1, Value1) pairs, the steps of calculating global designated values, the steps of calculating similarity values and the steps of generating median similarity values by executing a set of instructions storing in a machine readable storage medium.

In some embodiments, a computer program product tangibly embodied in a machine readable storage medium and comprising instructions that when executed by a processor perform a method for generating initial cluster centroids. The method includes calculating global designated values, among a plurality of input datasets, to be reference values. The method also includes calculating similarity values of the plurality of input datasets based on the reference values. The method further includes generating median similarity values based on the similarity values of the plurality of input datasets to generate corresponding initial cluster centroids.

In some embodiments, a computer system includes a processor and a computer-readable storage medium. The computer-readable storage medium has stored therein instructions that when executed by the processor perform a method for generating initial cluster centroids. The method includes generating (Key1, Value1) pairs of input datasets. The method also includes calculating global designated values, among the generated (Key1, Value1) pairs, to be reference values. The method also includes calculating similarity values of the input datasets based on the reference values. The method further includes generating (Key2, Value2) pairs of input datasets. The method further includes generating median similarity value, among the generated (Key2, Value2) pairs, to generate corresponding initial cluster centroids. The Key1 and the Value1 are a feature variable and a feature value, respectively, of corresponding input dataset. The Key2 and the Value2 are the similarity value and the feature value, respectively, of corresponding input dataset.

The sequences of the operations in the flowcharts 200-500 are used for illustration purpose. Moreover, the sequences of the operations in the flowcharts 200-500 can be changed. Some operations in the flowcharts 200-500 can be skipped, and/or other operations can be added without limiting the scope of claims appended herewith.

While the disclosure has been described by way of examples and in terms of disclosed embodiments, the invention is not limited to the examples and disclosed embodiments. To the contrary, various modifications and similar arrangements are covered as would be apparent to those of ordinary skill in the art. Therefore, the scope of the appended claims should be accorded the broadest interpretation so as to encompass such modifications and arrangements.

What is claimed is:

1. A method of generating initial cluster centroids using a processor, comprising:
using the processor, generating (Key1, Value1) pairs of input datasets;
using the processor, calculating global designated values, among the generated (Key1, Value1) pairs, to be reference values;
using the processor, calculating similarity values of the input datasets based on the reference values; and
using the processor, generating median similarity values based on the similarity values of the input datasets to generate corresponding initial cluster centroids,
wherein
the Key1 and the Value1 are a feature variable and a feature value,
respectively, of corresponding input dataset;
the processor runs the steps of generating (Key1, Value1) pairs, the steps of calculating global designated values, the steps of calculating similarity values and the steps of generating median similarity values by executing a set of instructions storing in a machine readable storage medium.

2. The method of claim 1, wherein the steps of generating (Key1, Value1) pairs, the steps of calculating global designated values, the steps of calculating similarity values and the steps of generating median similarity value are performed using MapReduce processes.

3. The method of claim 1, wherein the global designated values are global minimum values of corresponding input datasets.

4. The method of claim 1, wherein the global designated values are global maximum values of corresponding input datasets.

5. The method of claim 1, wherein a distance formula is used to calculate the similarity values.

6. The method of claim 1, further comprising generating, using the processor, (Key2, Value2) pairs of input datasets, wherein the Key2 and the Value2 are the similarity value and the feature value, respectively, of corresponding input dataset;

7. The method of claim 6, further comprising sorting, using the processor, the (Key2, Value2) pairs of input datasets in an increasing order based on respective “Key2” values.

8. The method of claim 7, further comprising dividing, using the processor, the (Key2, Value2) pairs of input datasets into N groups for N corresponding clusters such that the median similarity values are generated for each of N groups.

9. A computer program product tangibly embodied in a machine readable storage medium and comprising instructions that when executed by a processor perform a method for generating initial cluster centroids, the method comprising
calculating global designated values, among a plurality of input datasets, to be reference values;
calculating similarity values of the plurality of input datasets based on the reference values; and
generating median similarity values based on the similarity values of the plurality of input datasets to generate corresponding initial cluster centroids.

10. The computer program product of claim 9, further comprising generating (Key1, Value1) pairs of the plurality of input datasets such that the global designated values are generated based on the (Key1, Value1) pairs, wherein the Key1 and the Value1 are a feature variable and a feature value, respectively, of corresponding one of the plurality of input dataset.

11. The computer program product of claim 9, further comprising generating (Key2, Value2) pairs of the plurality of input datasets such that the median similarity values are generated based on the (Key2, Value2) pairs, wherein the Key2 and the Value2 are the similarity value and the feature value, respectively, of corresponding one of the plurality of input dataset;

12. The computer program product of claim 9, wherein the steps of calculating global designated values, the steps of calculating similarity values and the steps of generating median similarity value are performed using MapReduce processes.

13. The computer program product of claim 9, wherein the global designated values are global minimum values in the plurality of input datasets.

14. The computer program product of claim 9, wherein the global designated values are global maximum values in the plurality of input datasets.

15. The computer program product of claim 9, wherein a distance formula is used to calculate the similarity values.

16. The computer program product of claim 11, further comprising sorting the (Key2, Value2) pairs of input datasets in an increasing order based on respective “Key2” values.

17. The computer program product of claim 11, further comprising dividing the (Key2, Value2) pairs of input datasets into N groups for N corresponding clusters such that the median similarity values are generated for each of N groups.

18. A computer system comprising:
a processor; and
a computer-readable storage medium having stored therein instructions that when executed by the processor perform a method for generating initial cluster centroids, the method comprising:
generating (Key1, Value1) pairs of input datasets;
calculating global designated values, among the generated (Key1, Value1) pairs, to be reference values;
calculating similarity values of the input datasets based on the reference values;
generating (Key2, Value2) pairs of input datasets; and
generating median similarity value, among the generated (Key2, Value2) pairs, to generate corresponding initial cluster centroids,
wherein
the Key1 and the Value1 are a feature variable and a feature value,
respectively, of corresponding input dataset;
the Key2 and the Value2 are the similarity value and the feature value,
respectively, of corresponding input dataset.

19. The computer system of claim 18, wherein the step of generating (Key1, Value1) pairs, the steps of calculating global designated values, the steps of calculating similarity values, the step of generating (Key2, Value2) pairs and the steps of generating median similarity value are performed using MapReduce processes.

20. The computer system of claim 18, wherein the global designated values are global minimum values in the input datasets.
